(19) United States
(12) Patent Application Publication
(10) Pub. No.: US 2026/0001245 A1
(43) Pub. Date: Jan. 1, 2026

(54) ELECTRIC SHAVER AND SHEAR FOIL CUTTER SYSTEM THEREOF

(71) Applicant: Braun GmbH, Kronberg (DE)

(72) Inventors: Nicolas Siegfried Linder, Oberursel (DE); Thorsten Andreas Pohl, Muehlheim A.M. (DE); Jonathan Friedrich Dotzauer, Schwalbach (DE); Renata Burghardt, Kronberg (DE)

(21) Appl. No.: 19/251,085

(22) Filed: Jun. 26, 2025

(30) Foreign Application Priority Data
Jun. 28, 2024 (EP) 24185511.3

(51) Int. Cl. B26B 19/38

(52) U.S. Cl. CPC B26B 19/384; B26B 19/3846

(57) ABSTRACT

The present invention relates to a shear-foil-type cutter system for an electric shaver, said cutter system including an upper cutter having at least one field of perforations and a lower cutter pressed against said upper cutter having a particular dense blade geometry of the lower cutter and large overlap angle with the upper cutter,

### FIELD OF THE INVENTION

The present invention relates to cutting body hair such as beard stubbles. More particularly, the present invention relates to a cutter system for an electric shaver and/or trimmer, comprising a pair of cooperating cutting elements including a shear foil with at least one field of cutting perforations and a lower cutter including a plurality of cutter bars, wherein said cutting elements are movably supported relative to each other to cut hair extending said perforations. In particular, the invention relates to a lower cutter for a shear-foil type cutter system of an electric shaver.

### BACKGROUND OF THE INVENTION

Electric shavers utilize various mechanisms to provide hair cutting functionality. Some electric shavers include a perforated shear foil cooperating with a lower cutter movable relative thereto so as to cut hairs entering the perforations in the shear foil. Such shear foil type shavers are often used on a daily basis to provide for a clean shave wherein short beard stubbles are cut immediately at the skin surface.

In addition, cutter systems for longer hairs may be integrated into such electric shavers or trimmers which at the same time may be provided with the aforementioned shear foil cutters. For example, cutting elements may include two rows of comb-like cutting teeth arranged, for example, at opposite sides of the cutting elements and a field of shear foil-like cutting perforations between said rows of comb-like cutting teeth.

For example, EP 24 25 938 B1 shows a shaver with a pair of long hair trimmers integrated between shear foil cutters. Furthermore, shear foil like cutting perforations for cutting short hairs and comb-like cutting teeth for cutting longer hairs or stubbles may be integrated into the same cutting elements.

So as to increase cutting efficiency of such shear foil type cutter systems, the number of cutting actions per time unit should be rather high. One approach to achieve such high number of cutting actions is to increase driving speed or frequency at which the lower cutter and upper cutter move relative to each other. Typically, such relative movement may be a reciprocating movement, wherein it may be the lower cutter or lower cutter that reciprocates. Nevertheless, also the upper cutter may reciprocate in addition or in the alternative. Reciprocating movement may be linear or rotatory. On the other hand, such relative movement also may be a continuous rotatory movement, wherein again it may be the lower cutter that rotates. When having a longitudinal cutter system including an elongated lower cutter reciprocating relative to an also elongated upper cutter, reciprocating frequency cannot be increased in an unlimited way. Often electric shavers include spring loaded swing systems, e.g. comprising a so called oscillation bridge or linear motors inherently comprise spring systems to keep the motor running. By such systems optimal frequencies are determined by the resonant frequency of the system or around that resonant frequency—thus providing another limiting factor.

Thus, another approach to increased cutting efficiency includes increasing the number of cutting blades as one may go on the assumption that an increased number of cutting blades may achieve an increased number of cutting actions per time when moving at a certain speed comparable to the speed of a cutter having a smaller number of blades.

For such shear foil type cutter systems, it is, however, difficult to increase the number of blades of the lower cutter for several reasons. One assumption is that the cutting edges of neighboring blades need to be spaced apart from one another a certain distance, i.e. the gap between the blades would need some width so as to reliably allow the beard stubbles to get between the blades deep enough. Such beard stubbles first need to find and penetrate one of the perforations in the shear foil of the upper cutter and furthermore, needs to fully dive into the gap between two neighboring blades of the lower cutter so as to ensure cutting the stubbles indeed very close to the skin.

Another relevant problem with increasing the number of blades is the necessary strength and rigidity of the strip-like blades. Such strips forming the blades are quite slim. Lower cutters are typically made from a metal sheet which is rather thin, wherein typical metal sheets used for manufacturing lower cutters have a thickness of significantly less than 1 mm, e.g. a couple of tenth of a millimeter. On the other hand, the strips forming the blades also have a rather small width, i.e. their extension in the plane of the metal sheet is also small. Taking into account the U-shaped cross-section that means the strips form a sort of arch, it is clear that the strips need to take up significant bending stresses when reciprocating under the shear foil of the upper cutter. In particular, the lower cutter is pressed against the upper cutter so a major part of the contact forces are applied to the center section or middle section of the strips. At the same time, a major portion of the cutting actions occurs at such middle section so in view of all these circumstances, the frictional forces and the reaction forces due to cutting actions cause major bending stresses in the strips, wherein such bending stresses cumulate to stress peaks at the base portions of the strips where the strips are directly connected to the end portions of the lower cutter. Due to such bending stresses, the arch-like strips may be deflected or twisted what is detrimental to well-set contact of the strips to the upper cutter. In worst case cracks may occur and the strips finally may brake at their root or base portion.

Thus, so as to give the strips sufficient strength and rigidity to resist the frictional and cutting forces to withstand the bending stresses implied thereby at the root sections or base sections, the strips need to have sufficient material and thus, sufficient width and thickness.

For example, document EP 23 03 524 B1 and document U.S. Pat. No. 8,732,961 B2 show lower cutters for such shear foil type cutter systems having rather slim strips forming the blades, wherein it is suggested by said documents to give the strips a bone-shaped configuration. More particularly, the blades taper from the edge regions towards the middle via two concave inner radii between which a convex outer radius is provided.

US-A1-2015-0020389 discloses a lower cutter with blades having a distance between two cutting edges of adjacent strips of 0.8 mm, which leads in the context of the other geometries of the blades to a rather inefficient number of 27 blades overall—no length measures are provided.

### SUMMARY OF THE INVENTION

It is an objective underlying the present invention to provide for an improved cutter system avoiding at least one of the disadvantages of the prior art and/or further developing the existing solutions.

A more particular objective underlying the invention is to provide for an improved lower cutter having multiple blades in the form of strips allowing for high-efficiency hair cutting without sacrificing durability and tool lifetime of the cutter system to avoid short interval replacements.

Another objective underlying the present invention is to design an improved lower cutter able to achieve a high number of cutting actions at a limited driving speed and having sufficient strength and rigidity to take up bending stresses occurring due to cutting actions and friction.

At least one of the above objectives is addressed by the features of claim 1. Further advantageous features are provided by the further subclaim features. According to an aspect, it is suggested to arrange the blades at a rather short distance apart from each other to increase cutting actions without sacrificing strength and stiffness or hindering beard stubbles from diving deep into the gaps between the cutting edges of the blades. The blades may be evenly distributed along a longitudinal axis of the lower cutter at a density of more than 1.05 or more than 1.10 blades per 1 mm longitudinal axis length. Said longitudinal axis may be the axis of reciprocating movements of the lower cutter and the upper cutter relative to each other and/or may be substantially perpendicular to the cutting edges of the blade. Thus, a blade distance which may be the distance from a center line of one blade to the center line of the next blade, may range from 0.80 to 0.95 mm or from 0.85 to 0.90 mm. Such density of blades per longitudinal extension combines high hair cutting efficiency with sufficient strength and rigidity. Said blade strips have a width in a middle section of said strips, wherein a ratio of a/the length of said strips to said width is less than 30 wherein at least 33 blades are formed in the lower cutter and wherein said lower cutter contacts said upper cutter over a contact surface which, when considering the U-shaped cross-section of said upper cutter, extends over an angle (α) ranging from 100° to 130°. Thus an unusual dense lower blade arrangement allows for more cutting events to happen per reciprocating back and forth movement relative to the static upper shear foil blade. A large overall overlap range for sharp lower blade edges increase further the efficiency to also cut hairs entering the shear foil at its side holes. Such an arrangement is not found in the prior art due to lacking strength by to narrow blades. It was found that the combination of the number of blades over an overlap angle between upper and lower blade and the density of more than 1.05 blades per 1 mm lateral length extension of the lower cutter if both are pressed against each other provide sufficient strength and durability.

Due to the dense arrangement of the blades a high number of cutting actions may be achieved at a still limited, reasonable speed such as reciprocating speed. On the other hand, the blades are still sufficiently spaced from each other to allow for sufficient blade width and sufficiently wide gaps between the cutting edges. Too narrow gaps between blades would reduce the efficiency as thicker hairs are less likely captured and cut.

More particularly, the length of the strips may be relatively short, whereas the length or height of the end portions of the lower cutter may be relatively large/high. When considering the U-shaped cross-section, increasing the length/height of the base sections and at the same time decreasing the length of the strips may help to reduce and take up bending stresses in the root sections of the strips, i.e. where the strips are directly connected to the end sections since frictional forces and reaction forces due to cutting actions applied to the middle sections of the strips have a reduced lever arm relative to the base portions of the strips where the strips are connected to the end sections. In addition, increasing the height of the end sections, when considering the U-shaped cross-section, increases rigidity. All in all, cutting efficiency can be increased without sacrificing strength and lifetime.

So as to allow for a sufficiently large contact area between the lower cutter to the upper cutter, the U-shaped cross-section may include curved sections which are formed by said end sections and which continue a curvature of the strips. In other words, also the end sections may be curved in cross-section and the curvature of the U-shaped cross-section does not end at the ends of the strips, but continuous in the end sections. Thus, the strips may contact the upper cutter which may include a perforated shear foil, over the entire length—or a major part thereof—of the strips so efficient cutting action may be achieved also at the end portions of the strips and the cutting edges provided in such end portions as the end portions of the strips are still in sufficient contact to the upper cutter to allow cutting action. Therefore, despite a rather short length of these strips, a sufficiently large portion of the U-shaped cross-section may be provide for effective cutting.

For example, the contact area at which the lower cutter, when considering the U-shaped cross-section, contacts the upper cutter, may extend over an angle of 100° to 130° although the strips may extend, when considering said U-shaped cross-section, only along an angle of 160° or 150° or even less. As the lower cutter is usually pressed against the upper cutter, some widening of the upper cutter at the end portions is necessary to allow for sufficient contact forces in the middle section so the aforementioned angle ratio may be provided.

These and other advantages become more apparent from the following description giving reference to the drawings and possible examples.

### BRIEF DESCRIPTION OF THE DRAWINGS

FIG. 1: a perspective, exploded view of an electric shaver according to an example showing the upper cutter including a perforated shear foil removed from the lower cutter of the shavers cutter system,

FIG. 2a-2b: a cross-sectional view of the lower cutter biased against the upper cutter illustrating the U-shaped cross-section of the lower cutter, wherein enlarged partial view FIG. 2(b) shows a detail of partial view FIG. 2(a) and illustrates the curved portion of the lower cutter extending from the strip-like blades into the end sections and furthermore, the upper cutter no longer in contact with the lower cutter at the base portion of the strips merging the end section of the lower cutter,

FIG. 3: a perspective view of the lower cutter showing the arch-shaped strips forming the blades of the lower cutter,

FIG. 4a: a side view of the lower cutter showing an end section and the strip-like blades connected to said end section,

FIG. 4b: a cross sectional view along B-B in FIG. 4a through the middle of the blade strip,

FIG. 5a-5f: detailed views of the lower cutter of the preceding figures, wherein partial view FIG. 5(a) shows a top view of the entire lower cutter illustrating the plurality of blades, partial view FIG. 5(b) illustrates the length of the strip-like blades, partial view FIG. 5(c) illustrates the curved transition between two strips at their base portions merging with the end section, partial view FIG. 5(d) illustrates the width of a strip, partial view FIG. 5(e) illustrates the distance between neighboring strips and partial view FIG. 5(f) illustrates the connection area of the lower cutter,

FIG. 6: a view of one strip forming a blade of the lower cutter of the preceding figures, and

FIG. 7: a schematic cross-sectional view illustrating the geometry of the curvature of the strips and end sections of the lower cutter.

### DETAILED DESCRIPTION OF THE INVENTION

So as to combine high-efficiency hair cutting without sacrificing durability and tool lifetime of the cutter system to avoid short interval replacements, it is suggested to arrange the blades at a rather short distance apart from each other to increase cutting actions without sacrificing strength and stiffness or hindering beard stubbles from diving deep into the gaps between the cutting edges of the blades.

According to an aspect, the blades may be evenly distributed along a longitudinal axis of the lower cutter at a density of more than 1.05 or more than 1.10 blades per 1 mm longitudinal axis length with said longitudinal axis being the axis of reciprocating movements of the lower cutter and the upper cutter relative to each other and/or substantially perpendicular to the cutting edges of the blade. Thus, a blade distance which may be the distance from a center line of one blade to the center line of the next blade, may range from 0.80 to 0.95 mm or from 0.85 to 0.90 mm. Such density of blades per longitudinal extension combines high hair cutting efficiency with sufficient strength and rigidity.

In particular, said blades may be distributed along the longitudinal axis of the lower cutter at a density ranging from 1.10 to 1.30 or from 1.10 to 1.20 or from 1.13 to 1.17 blades per 1 mm longitudinal axis length of the lower cutter. For example, the distance between neighboring blades, when considering a center line or axis of symmetry of the strips, may range from 0.86 to 0.88 mm. Such distancing combines high cutting efficiency with sufficient space for designing the strips with sufficient material to provide for necessary strength and rigidity.

Due to the dense arrangement of the blades a high number of cutting actions may be achieved at a still limited, reasonable speed such as reciprocating speed. On the other hand, the blades are still sufficiently spaced from each other to allow for sufficient blade width and sufficiently wide gaps between the cutting edges.

More particularly, in comparison to previous lower cutter designs, the length of the strips may be reduced, whereas the length or height of the end portions of the lower cutter may be increased. When considering the U-shaped cross-section, increasing the length/height of the base sections and at the same time decreasing the length of the strips may help to reduce and take-up bending stresses in the root sections of the strips, i.e. where the strips merge with the end sections of the lower cutter since frictional forces and reaction forces due to cutting actions applied to the middle sections of the strips have a reduced lever arm relative to the base portions of the strips where the strips are connected to the end sections. In addition, increasing the height of the end sections, when considering the U-shaped cross-section, increases rigidity of the support structure for the strips. All in all, cutting efficiency can be increased without sacrificing strength and lifetime.

Reducing the strips' “length” and at the same time increasing the “length” or height of the end sections may be expressed by the ratio of the strip length to the entire length or entire cross-sectional extension of the lower cutter, when considering the U-shaped cross-section. In fact, such “lengths” are extensions of a curved path around the U-shaped cross-section and thus, a sort of peripheral lengths. Advantageously, each of the strips or each of at least some of said strips may have a length that is less than 75% of the entire cross-sectional extension of the lower cutter measured along the U-shaped cross-section including the strip and the adjoining end sections. Such ratio of 3 to 4 or less allows the strips to have a very small width without sacrificing sufficient strength. Since the level arm of forces acting on the middle section of the bowed strips is reduced to the reduced strip length, the strips are capable of taking up the arising bending stresses.

More particularly, each of at least some of the strips may have a length ranging from 75% to 65% or from 75% to 70% of said entire cross-sectional extension of the lower cutter.

A minimum width of the strips may be given in a middle section of the strips which generally may have a bone-shaped configuration, wherein the width of a strip may taper from both edge regions towards the middle. Such tapering may be monotonic and/or continuous. Nevertheless, the strips may have a middle section in which said width is constant so the tapering takes place in outer sections and/or base sections of the strips neighboring such middle section.

Irrespective of the exact tapering configuration, the width of the strips may range from about 0.29 to about 0.36 mm. Irrespective of the exact value of the width, the ratio of the length of the strips to said width of the strips may be less than 30 and/or may range from 30 to 21 or from 22 to 29. Such length-width-ratio keeps the strips sufficiently strong and rigid.

As is it rather the maximum width of the strips that restricts a high density of the blades in terms of the maximum number of blades per longitudinal extension of the lower cutter, the strips may have a maximum width that is less than 0.57 mm, wherein such maximum width of the strips may be given at the base portions of the strips where the strips merge with the end sections of the lower cutter. Such maximum width of less than 0.57 mm allows for a very dense arrangement of blades but still allows for sufficient rounding of the contour between neighboring base portions of neighboring strips so as to avoid stress peaks due to transitions between neighboring strips being too pointy or too sharp, and to reduce a tendency to cracks at such base portions.

Advantageously, the strips may have a width at the base portion thereof ranging from 0.57 to 0.45 mm or from 0.57 to 0.48 mm.

So as to avoid excessive stresses at the base portions of the strips merging with the end sections, but still allowing for high density of the blade arrangement, the transition between neighboring strips at the base portions thereof may be curved at the radius ranging from 0.12 to 0.175 mm or from 0.12 to 0.16 mm. Advantageously, said radius may be 0.145 mm or more and 0.155 mm or less.

In order to reduce bending stresses in said end sections and/or increasing bendability of said end sections, said end sections are provided with a partial or complete change in the thickness or provided with a at least partial thinning relative to the thickness of the blades. So, the end sections may be at least partially thinner than the more central blade section. For this purpose, the sheet of the lower cutter may be deformed, ablated or otherwise material removed (e.g. by in-etching) in order to create such thinned portions. Other possibilities for reducing bending stresses at the end sections comprise a surface structure including indentations and/or dints and/or ripples and/or corrugations.

So as to allow for, despite the reduced length of the strips, a sufficiently large contact area between the lower cutter to the upper cutter, the U-shaped cross-section may include curved sections which are formed by said end sections, and which continue a curvature of the strips. In other words, also the end sections may be curved in cross-section and the curvature of the U-shaped cross-section does not end at the ends of the strips, but continuous in the end sections. Thus, the strips may contact the upper cutter which may include a perforated shear foil, over the entire length—or a major part thereof—of the strips so efficient cutting action may be achieved also at the end portions of the strips and the cutting edges provided in such end portions as the end portions of the strips are still in sufficient contact to the upper cutter to allow cutting action. Therefore, despite a rather short length of these strips, a sufficiently large portion of the U-shaped cross-section may be provided for effective cutting.

For example, the contact area at which the lower cutter, when considering the U-shaped cross-section, contacts the upper cutter, may extend over an angle of 100° to 130° although the strips may extend, when considering said U-shaped cross-section, only along an angle of 160° or 150° or even less. As the lower cutter is usually pressed against the upper cutter, some widening of the upper cutter at the end portions is necessary to allow for sufficient contact forces in the middle section so the aforementioned angle ratio may be provided.

The upper cutter against which the lower cutter is pressed, may include or may be formed by a shear foil including at least one field of perforations, wherein said field of perforations may cover the entire contact area in which the upper cutter is contacted by the lower cutter. For example, said field of perforations may extend, when considering the substantially U-shaped cross-section, over an angle ranging from 100° to 160° or from 120° to 150°.

The blades moving over—or one better should say under—said perforations may include sharp cutting edges having an angle of less than 90°. For example, the cutting edges may be sharp edges angled at an angle of less than 75° or less than 65°. For example, the cutting edges may have an angle ranging from 45° to 60° or from 45° to 55°.

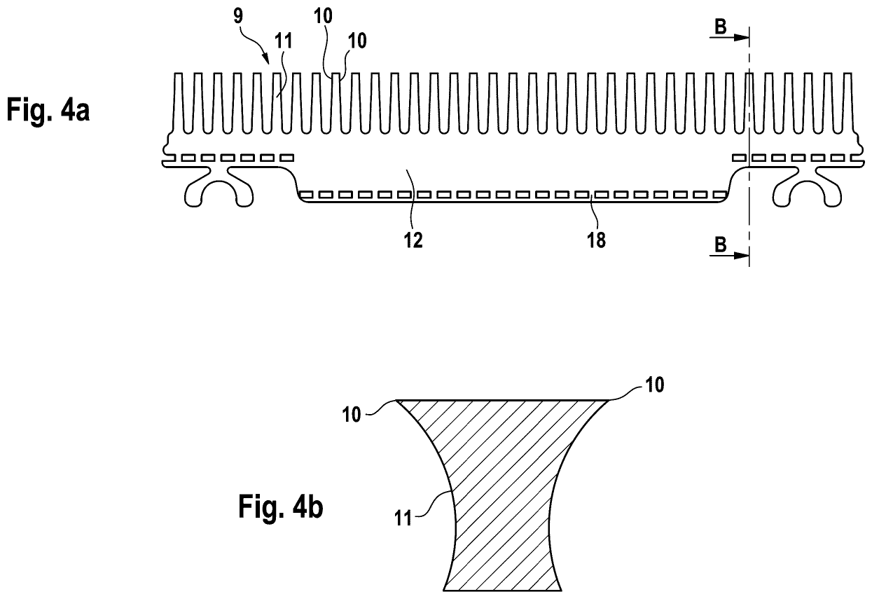

In cross-section, the strips may have a substantially trapezoidal contour with an upper surface facing the upper cutter having a width larger than an inner surface of the strips facing away from said upper cutter, cf. FIG. 4b. Such trapezoidal contour may define the aforementioned sharp cutting edges at the upper surface.

Contact pressure of the lower cutter against the upper cutter may be achieved by means of a biasing device urging the lower cutter against the upper cutter, wherein such biasing device may include one or more elastic springs. For example, one or more screw springs may be used to press the lower cutter against the upper cutter.

Basically, each of the cooperating cutting elements may be driven. However, to combine an easy drive system with safe and soft cutting action, the upper or outer cutting element having the skin contact surface may be standing and/or may be not reciprocating and not rotating, whereas the lower or inner cutting element which may be the sandwiched cutting element, may reciprocate or rotatorily oscillate.

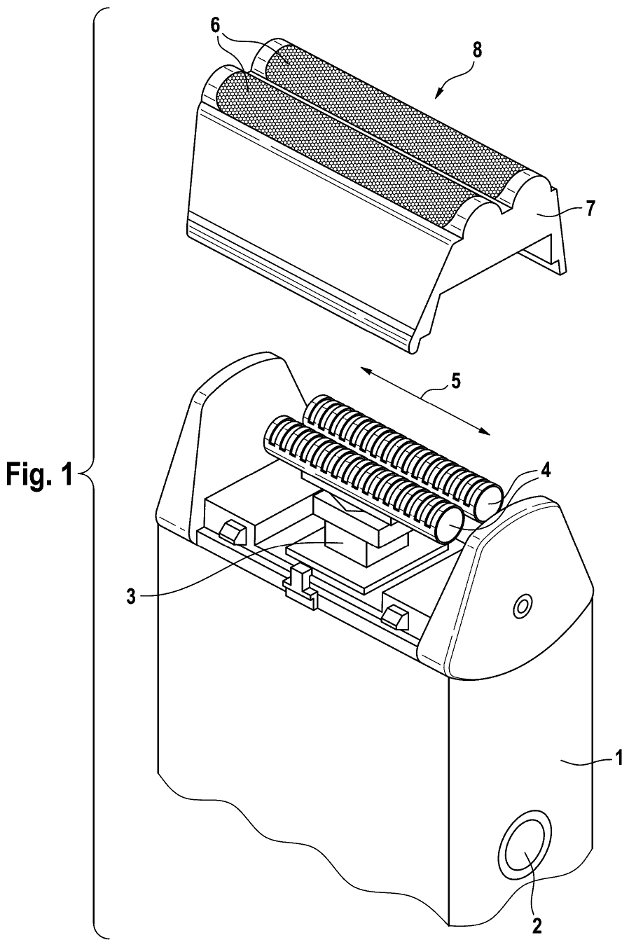

As can be seen from FIG. 1, the cutter system 8 may be part of a cutter head which may be attached to a handle 2 of a shaver and/or trimmer 1. More particularly, the shaver and/or trimmer 1 may include an elongated handle 2 accommodating the electronic and/or electric components such as a control unit, an electric drive motor or a magnetic drive motor and a drive train for transmitting the driving action of the motor to the cutter system at the cutter head which cutter head may be positioned at one end of the elongated handle 2, cf. FIG. 1. Said handle also may be provided with an on/off-switch, cf. FIG. 1

The cutter system 8 including a pair of cooperating cutting elements 4 and 6 may be the only cutter system of the cutter head as it is the case with the example shown in FIG. 1. On the other hand, the cutter system 8 may be incorporated into a shaver head having other cutter systems such as comb-like long hair cutters or trimmers with cutting teeth, wherein, for example, such cutter system 3 having at least one row of cooperating cutting teeth may be positioned between a pair of shear foil cutters, or, in the alternative, may be positioned in front of such a shear foil cutter.

As shown by FIG. 1, the cutter system 8 may include a pair of lower cutters 4 supported and/or fixed on a driving element 3 which may drive said pair of lower cutters 4 in a reciprocating manner along reciprocating access 5. Said axis 5 of driving motion is substantially parallel to the longitudinal axis of said basically elongated lower cutters 4 which may be arranged parallel to each other, cf. FIG. 1. FIG. 1 is meant to illustrate the general design of such shavers but not that of the preferred lower cutters specifically. FIG. 1 shows another type of lower cutter, i.e. made from a fully cylindrical metal body. The description of the invention hereinbelow relates to a lower cutter type made from a sheet of metal that is bend in arch shape-or better U-shaped in cross section-and held in that shape by and additional plastic support part to which the bend metal cutter part is fixed.

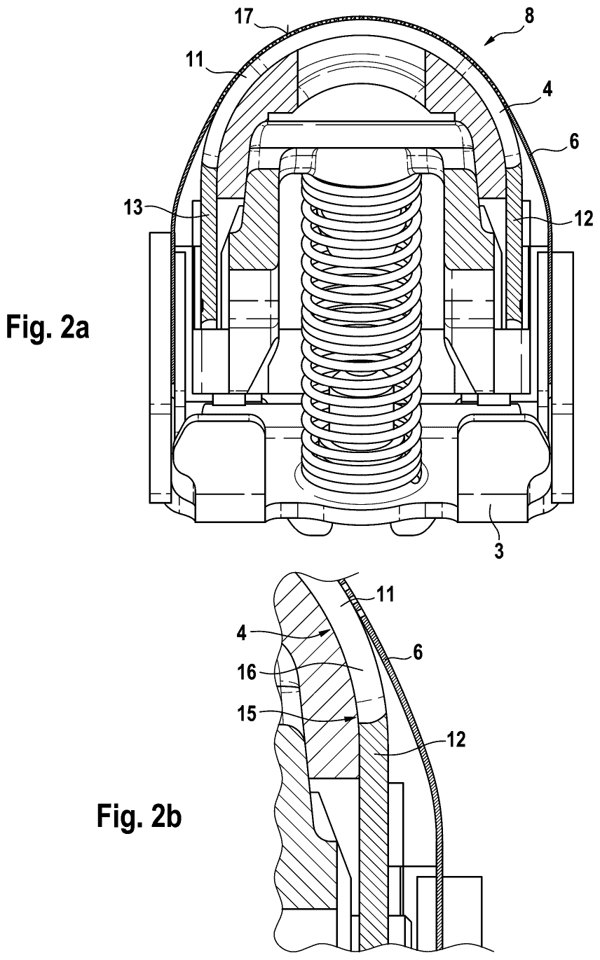

As can be seen from FIGS. 2a-2b, said lower cutters 4 may be rigidly fixed to said driving element 3 with regard to said axis 5 of motion so the driving action of the driving element 3 is rigidly transmitted to the lower cutters 4. On the other hand, the lower cutters 4 may move relative to said driving element 3 in a direction perpendicular to said axis 5 of motion. In particular, the lower cutters 4 may be supported on said driving element 3 movably in a direction towards the upper cutter 6 so as to apply contact pressure between the two cutters 4, 6. For example, the lower cutters 4 may be urged towards the upper cutters 6 by means of a spring device, cf. FIG. 2a-2b.

For example, the drive system may include a motor the shaft of which may rotate an eccentric drive pin which is received between the channel-like contours of a driver 3 which is connected to one of the cutting elements 4 which is caused to reciprocate due to the engagement of the rotating eccentric drive pin with the contours of said driver 3. Depending on the type of motor, other driver elements 3 may be provided.

The upper cutters 6 may be supported on a support frame 7 which may be attached to the handle side part of the cutter head so as to position the upper cutters 6 onto the lower cutters 4. Similar to the lower cutters 4, also the upper cutters 6 may have an elongated configuration extending parallel to said reciprocating axis 5.

The upper cutters 6 may include a shear foil comprising a field of perforations that may be penetrated by beard stopples to get cut by the blades 9 of the lower cutters 4 reciprocating under the perforated shear foil.

As shown by FIG. 1, the upper element 6 of the cooperating cutting elements 4 and 6 may be provided with at least one field of cutting perforations defining a skin contact surface of the cutter system 8 or may include multiple rows of perforations which may be formed as small sized through holes having a circular, oval, elliptical or polygonal shape.

As can be seen from FIGS. 2a-2b, both the lower and upper cutters 4, 6 may have a more or less U-shaped cross-section so the lower cutter 4, with its arch-shaped blades 9, may snuggly fit onto the inner surface of the dome-or barrel-shaped upper cutter 6, the outer surface of which forms a skin contact surface.

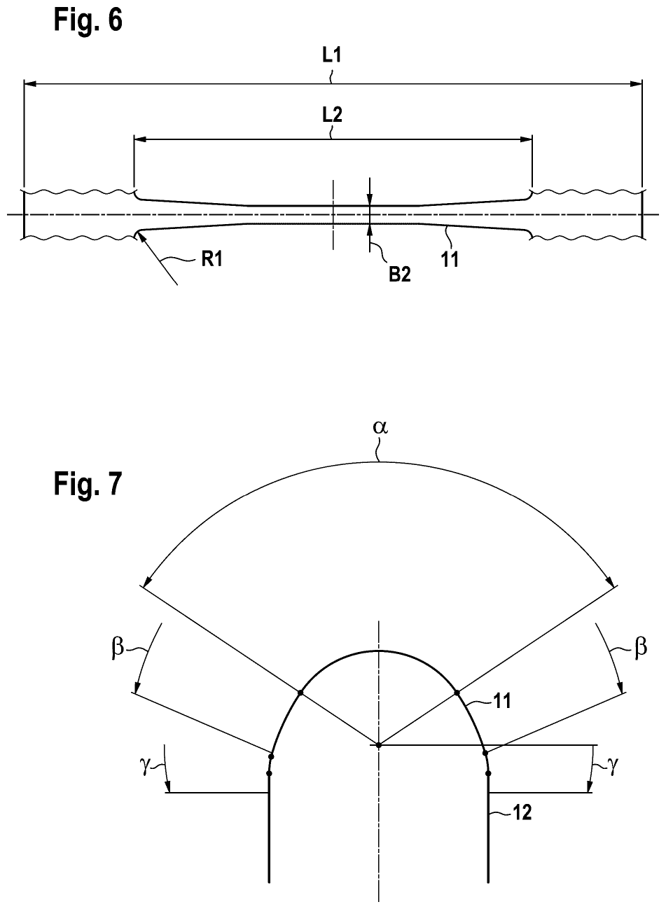

As can be seen from FIGS. 6 and 7, the contact area 17 in which the lower cutter 4 contacts the upper cutter 6, may extend, when considering said substantially U-shaped cross-section, over an angle α ranging from about 100° to 130° and more particularly from 110° to 120°. As can be seen from FIG. 2, partial view (b), the lower cutter 4 loses contact to the upper cutter 6 at the base portion 15 of the strips 11 that form the blades 9, since the upper cutter 6 does not exactly follow the U-shaped curvature of the lower cutter 4 at the end sections 12, 13 and the adjoining base portions 16 of the strips 11. The upper cutter 6 widens a bit more in this region.

Nevertheless, said U-shaped cross-section of the blades 9 includes curved sections 15 which are formed by said end sections 12, 13 and which continue a curvature of the strips 11, cf. FIG. 2b.

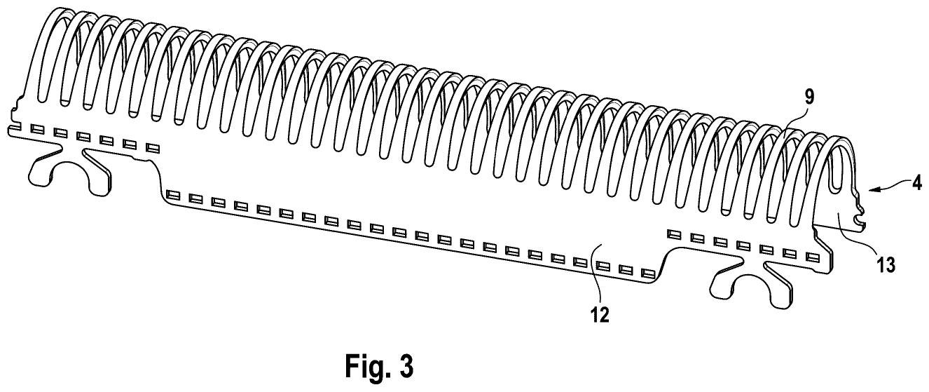

As can be seen from FIGS. 3, 4a and 5a-5f, the lower cutter 4 is provided with a dense arrangement of a plurality of blades 9 formed by strips 11 having cutting edges 10 on opposite sides thereof. Said strips 11 and thus, the cutting edges 10, extend substantially perpendicular to the reciprocating axis 5 and/or substantially perpendicular to the longitudinal axis of the lower cutter 4. Basically, said strips 11 form the curved section of the U-shaped cross-section and thus, have an arch-shape, cf. FIG. 3 and also FIG. 2a. In particular, said strips 11 may have a constant and/or continuous curvature and/or may be curved at a substantially constant radius like a circle.

Irrespective of the exact curvature, the strips 11 may extend along said U-shaped cross-section over an angle β, cf. FIG. 7 which is larger than the aforementioned angle α of the contact area. Said angle β defined by the strips 11 may range from about 140° to about 170°, wherein said angle β advantageously may range from 155° to 165°, wherein 160° could be a good choice for angle β.

Both said strips 11 and said end sections 12, 13 together may extend, when considering said U-shaped cross-section, over an angle (γ) of 180° or more, cf. FIG. 7.

As can be seen from FIGS. 3, 4a and 5a, the arrangement of the blades 9 is rather dense in terms of blades per longitudinal axis extension.

For example, when the field of blades 9 of the lower cutter 4 has a length, i.e. extends along longitudinal axis 15, which is parallel to reciprocation axis 5, about 30 mm, 33 or more blades 9 may be provided, wherein also 35, 36 or 37 blades could be provided at such blade field length, cf. FIGS. 3, 4a and 5a.

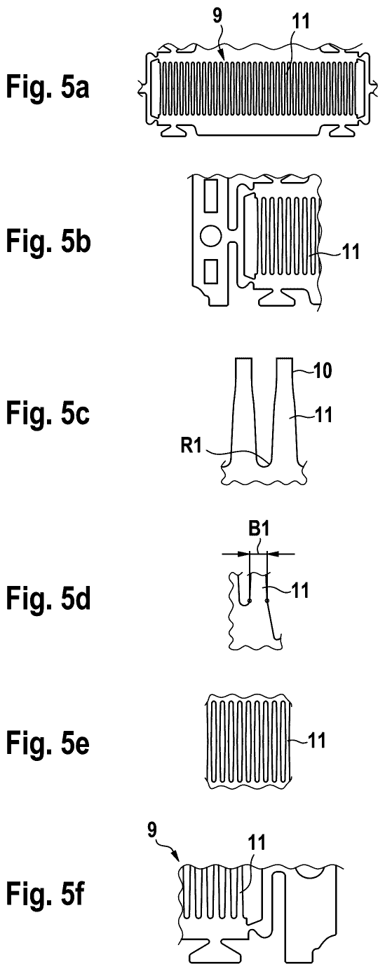

More generally, the blades 9 are evenly distributed along longitudinal axis 14 of the lower cutter 4 at a density of more than 1.05 or more than 1.10 blades per 1 mm longitudinal axis length. Thus, the blades 9, when considering the middle axis of strips 11, may be spaced apart from each other at a distance of about 0.85 to 0.90 mm, wherein 0.87 is an advantageous distance between neighboring blades 9, cf. FIG. 5, partial view (e).

As can be seen from FIG. 5, partial view (d), the strips 11 may have a width B1, at their base portions 16, ranging from 0.45 to 0.57 mm or from 0.48 to 0.57 mm, wherein, for example, said width may be 0.52 mm. Said width B1 of the strips 11 at the base portion 16 may be the maximum width of the strips 11.

On the other hand, said strips 11 forming the blades 9 may have, at their middle portions, a width B2 ranging from 0.30 to 0.35 mm, wherein said width may be 0.32 mm for example. Said width in the middle section of the strips 11 may be the minimum width thereof.

As can be seen from FIG. 6, the strips 11 may have the aforementioned tapered configuration.

As can be seen from FIG. 5, partial view (c), the transitional contour between the base portion 16 of neighboring strips 11 may be rounded at a radius R1 which may range from about 0.12 to about 0.16 mm or from 0.140 to 0.155 mm, wherein a radius R1 as of 0.150 mm could be provided.

As apparent from the above, the higher density of blades is possible to be provided over various overall lower cutter longitudinal axis extension lengths applying the above principles.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present disclosure have been illustrated and described, it would be obvious to those skilled in the art that various other changes and modifications can be made without departing from the spirit and scope of the invention. It is therefore intended to cover in the appended claims all such changes and modifications that are within the scope of this invention. Any reference signs in the claims should not be construed as limiting the scope.

1. A shear-foil-type cutter system for an electric shaver, said cutter system including an upper cutter having at least one field of perforations and a lower cutter pressed against said upper cutter, said lower cutter comprising a plurality of blades with cutting edges spaced apart from one another in the form of strips extending between two end sections and having a substantially U-shaped cross-section, characterized in that said blades are evenly distributed along a longitudinal axis of the lower cutter at a density of more than 1.05 or more than 1.10 blades per 1 mm longitudinal axis length, wherein said strips have a width in a middle section of said strips, wherein a ratio of a/the length of said strips to said width is less than 30 wherein at least a number of 33 blades are formed in the lower cutter and wherein said lower cutter contacts said upper cutter over a contact surface which, when considering the U-shaped cross-section of said upper cutter, extends over an angle ranging from 100° to 130°.

2. The cutter system according to claim 1, wherein said blades are distributed at a density ranging from 1.10 to 1.3 or from 1.10 to 1.20 or from 1.13 to 1.17 blades per 1 mm longitudinal axis length of the lower cutter.

3. The cutter system according to claim 1, wherein said U-shaped cross-section of the blades includes curved sections which are formed by said end sections and which continue a curvature of the strips.

4. The cutter system according to claim 1, wherein said strips extend, when considering said U-shaped cross-section, over an angle of less than 170° or ranging from 140° to 170° or from 150° to 170° or from 155° to 165°.

5. The cutter system according to claim 1, wherein said strips and said end sections together extend, when considering said U-shaped cross-section, over an angle of 180° or more.

6. The cutter system according to claim 1, wherein each of at least some of said strips have a length which is less than 75% or ranging from 75% to 65% or from 75% to 70% of an entire cross-sectional extension of the lower cutter measured along said U-shaped cross-section including the strip and the adjoining end sections.

7. The cutter system according to claim 1, wherein said strips have a width in a middle section of said strips, wherein a ratio of a/the length of said strips to said width (B2) ranges from 30 to 21 or from 22 to 29.

8. The cutter system according to claim 1, wherein said strips have a base portion directly connected to said end sections, wherein said strips have a width at said base portion of less than 0.57 mm or ranging from 0.57 to 0.45 mm or from 0.57 to 0.48 mm.

9. The cutter system according claim 1, wherein said strips define, with their base portions directly connected to said end sections a radius between each other which radius is less than 0.175 mm or ranges from 0.16 to 0.12 mm or from 0.155 to 0.145 mm.

10. The cutter system according to claim 1, wherein said end sections are provided with a partial or complete change in the thickness or provided with an at least partial thinning (18) relative to the thickness of the blades.

11. The cutter system according to claim 10, wherein a surface structure includes one of the following geometric provisions indentations, dints, ripples or corrugations for reducing bending stresses in said end sections and increasing bendability of said end sections.

12. The cutter system according to claim 1, wherein the lower cutter comprises more than 35 blades or it comprises one of a number of 35, 36 or 37 blades.

13. The cutter system according to claim 1, wherein said lower cutter contacts said upper cutter over a contact surface which, when considering the U-shaped cross-section of said upper cutter, extends over an angle ranging from 110° to 120°.
